(19) United States
(12) Patent Application Publication
(10) Pub. No.: US 2020/0390075 A1
(43) Pub. Date: Dec. 17, 2020

(54) MULTI-FUNCTIONAL ENVIRONMENTALLY-FRIENDLY FISHING ACCESSORY

(71) Applicant: Will H. Neubauer, Santa Barbara, CA (US)

(72) Inventor: Will H. Neubauer, Santa Barbara, CA (US)

(21) Appl. No.: 16/440,594

(22) Filed: Jun. 13, 2019

(51) Int. Cl. A01K 85/01; A01K 97/04

(52) U.S. Cl. CPC A01K 85/01; A01K 97/04

(57) ABSTRACT

A reusable, multi-function, low-cost, environmentally-friendly fishing accessory. The accessory provides greater flexibility over traditional fishing tackle. The accessory has multiple functions suited to different fishing environments. Depending on the payload, the accessory can provide a floatation effect, a sinking effect, a casting effect and/or a chumming effect. These effects can be tailored to improve the fishing experience, improve the user's chances of a successful catch through better targeting the location of the bait and/or the attractiveness of the fishing lure. The accessory provides many benefits across multiple modes of fishing, including bottom fishing, trolling, casting, surf fishing and specific thermocline depth fishing. The accessory can also accommodate sensors, test kits, and other payloads that allow the user to track and analyze variables such as temperature, depth, motion, and other environmental factors while fishing.

### BACKGROUND

Hook and line fishing can be an effective mode of catching fish in a variety of fishing environments and for different types of target fish. Different environments, from shallow lakes and streams to beaches to deep-sea fishing, require different approaches and techniques. In addition, different types of target fish may also require different approaches and/or equipment. For instance, some situations call for sinkers while others require floaters. In addition, some fishing situations benefit from olfactory enticements such as chum or smelt oil.

Bait cages can be loaded with bait and attached to fishing lines to attract fish. These cages are often designed to remain relatively stationary in the water and tend to be rigid in construction and have irregular shapes with corners and/or edges that are prone to getting caught or stuck on rocks and other debris in more dynamic fishing applications. In addition, when drawn through the water, irregularly shaped cages may twist and turn in ways that tend to tangle or otherwise foul up the rig or line.

Chum bags may also be loaded with bait or chum and drawn along with a trolling rig to attract fish. However, chum bags tend to be made of softer materials that are prone to getting stuck on sharp edges on rocks or other debris in the water, making them unsuitable for shallower fishing environments.

Fishing sinkers typically take the form of metal weights that can be tied, clamped, or otherwise fastened to a fishing line. Often these weights are formed of lead or other high-density metals. Unfortunately, heavy metals such as lead can leech into water and are toxic to many forms of life, including aquatic plants and animals. In addition, sourcing these metals often requires mining and other activities that negatively impact the environment.

### SUMMARY

What is needed is an adaptable and reusable fishing accessory that can provide any or a combination of sinking, floating, enticing, sensing, and other functions as needed to facilitate different types of fishing in a variety of environments. In addition, it would be desirable to provide an adaptable fishing accessory that can operate as a sinker or floater with less environmental impact than traditional sinkers and floaters. Further, it would be desirable to provide an adaptable fishing accessory that permits the use of improvised or ad-hoc elements available in the angler's environment to achieve the various functions mentioned above. Finally, it would be desirable to provide a fishing accessory that has a shape that can be adjusted or varied to achieve different hydrodynamic properties.

To achieve these ends, this disclosure provides an adaptable fishing accessory comprising a generally spherical elastic cage that can be coupled to a fishing line. The mesh can accommodate a variety of contents or payload to adapt the fishing line to different fishing environments or purposes. For example, the cage could be loaded with an object denser than water to provide a sinking function, an object lighter than water to provide a floating function, live bait or olfactory enticements to attract fish, and/or a submergible sensor to provide a data collection function.

### BRIEF SUMMARY OF THE DRAWINGS

FIG. 1 is a view of an exemplary fishing accessory in use with a fishing rod.

FIG. 2 is a detailed view of an exemplary fishing accessory.

FIG. 3 is a view of an exemplary fishing accessory being coupled to a fishing line.

FIG. 4 is a view of a cross section of an exemplary closure mechanism of the disclosed fishing accessory.

FIG. 5 is a view of an exemplary fishing accessory being coupled to a fishing line with a second closure mechanism.

FIG. 6 is a view of an exemplary fishing accessory coupled to a fishing line with a second closure mechanism.

### DETAILED DESCRIPTION

The following description includes aspects of a multi-function, low-cost, environmentally-friendly fishing accessory. The accessory provides greater flexibility over traditional fishing tackle. The accessory has multiple functions suited to different fishing environments. Depending on the payload, the accessory can provide a sinking function, floating function, a casting function, a chumming function, and/or a data collection function. These functions can be employed to improve the user's chances of a successful catch through better targeting the location of the bait and/or enhancing the attractiveness of the bait, hook, or lure. The accessory provides many benefits across multiple modes of fishing, including bottom fishing, trolling, casting, surf fishing and specific thermocline depth fishing. The accessory is reusable and allows the angler to quickly swap payloads to achieve different functions without having to tie a new rig.

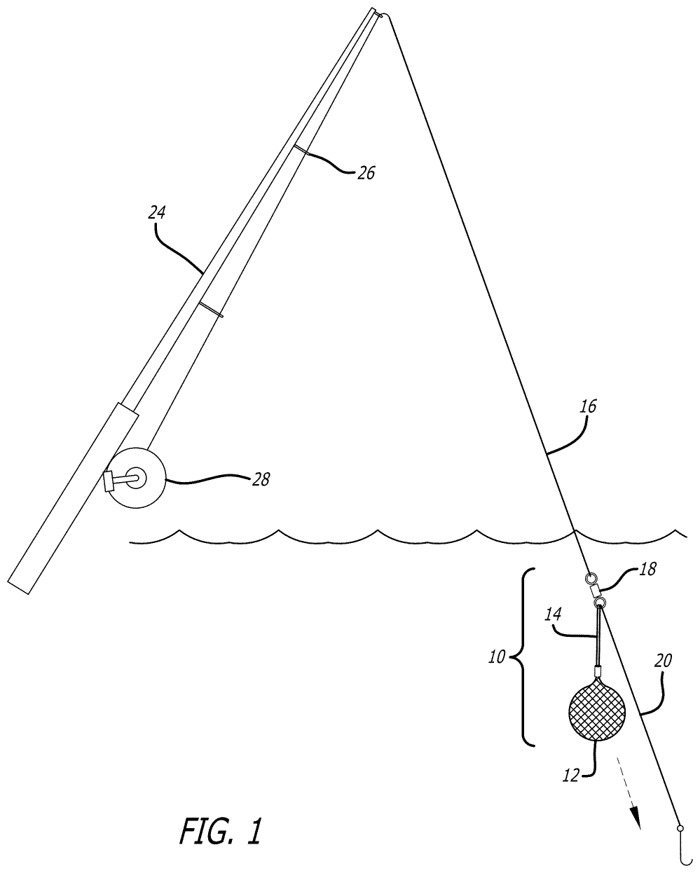

With reference to the drawings, FIG. 1 illustrates an exemplary multi-functional fishing accessory 10 in accordance with the disclosure. The fishing accessory 10 includes a flexible, elastic mesh cage or enclosure 12 and a leash 14 that can be attached to a fishing line 16. The leash 14 may be coupled directly to the fishing line 16 or coupled to a swivel 18 or other tackle that is in turn coupled to the fishing line 16. In the illustrated embodiment, the leash 14 is coupled to a swivel 18 that is in turn coupled to the fishing line 16. The swivel 18 may also be coupled to a leader 20 that is connected to a hook or lure 22. The other end of the fishing line 16 is connected to a fishing rod 24. The fishing rod 24 may include one or more eyes or guides 26 through which the line 16 is fed back to a reel 28.

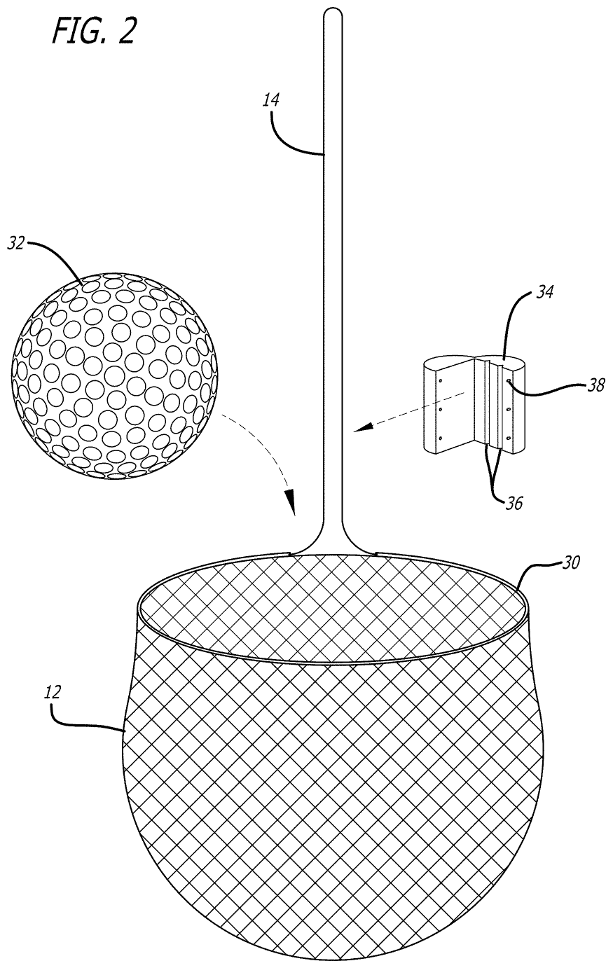

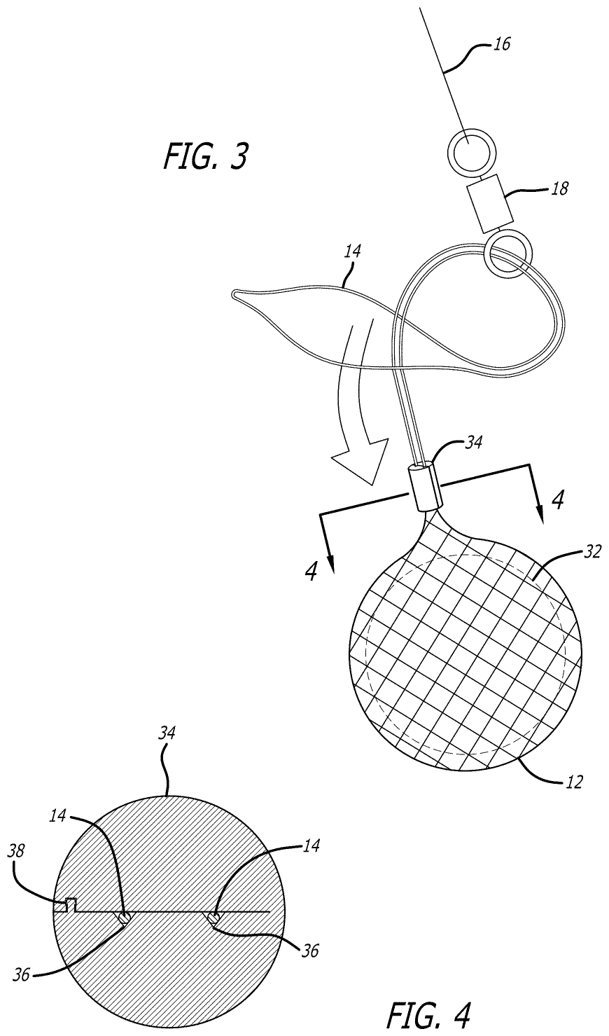

FIG. 2 illustrates a detailed view of an exemplary fishing accessory 10 in accordance with the disclosure. The leash 14 may be threaded through a channel along the periphery of an opening 30 of the enclosure 12. When the leash is relaxed, it allows the opening 12 to expand or open, as shown in FIG. 2. In this state, a user may insert a payload 32 into the enclosure 12 through the opening 30. Once the payload 32 is inserted into the enclosure 12, the leash 14 may be pulled away from the enclosure 12 to shrink or cinch the opening 30 and secure the payload 32 within the enclosure 12. With the payload 32 inside the enclosure 12 and the opening 30 cinched shut, a clamp or clasp 34 may be fastened or otherwise attached to the leash just above the opening 30 to secure the payload 32 within the enclosure 12 as shown in, e.g., FIG. 3. As shown in FIG. 2, the clasp 34 may take the form of two half-cylinders that are hinged on a first side to allow the opposite side to be opened or closed around the fishing line 16.

FIG. 3 illustrates one example of how the fishing accessory 10 may be attached to the fishing line 16 once the mesh enclosure 12 is loaded with a payload. With the payload 34 secured within the enclosure 12 and the clasp 34 closed around the leash 14, the free end of the leash may be threaded through an eye of a swivel 18 and then the enclosure 12 may be passed through the free end of the leash 14, as shown in FIG. 3. The same procedure could be used to attach the accessory to any other tackle on the fishing line 14 or directly to the fishing line itself. Alternatively, the leash could be coupled to tackle or the fishing line using a knot, clamp, or any other fastening technique.

FIG. 4 shows a cross-section of an exemplary clasp 34 in accordance with the disclosure. The interior of the clasp may include one or more channels or grooves 36 that run the length of the clasp. The grooves 36 may be just wide and deep enough to receive the leash segments that run through the clasp 34 while still creating ample friction between the clasp 34 and the leash 14 when the clasp 34 is closed. The friction should be sufficient to ensure the clasp 34 does not slide up or down the leash under forces resulting from casting or trolling the line and/or landing a fish. The clasp 34 may also include one or more nubs 38 that engage with corresponding recesses on the opposing side of the clasp to hold the clasp firmly shut around the leash 14.

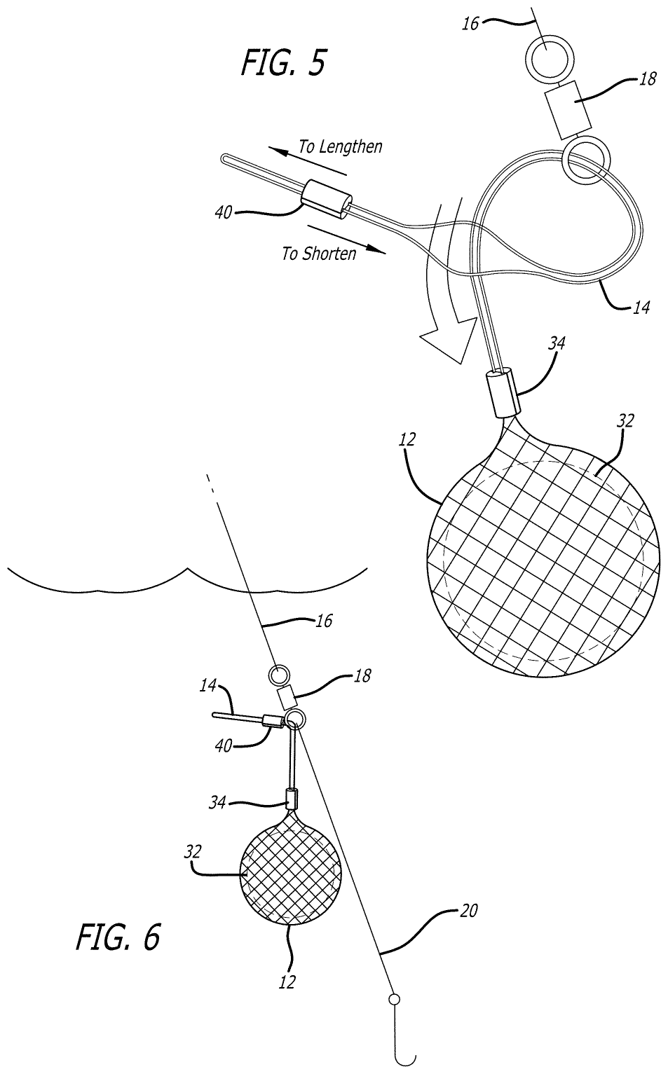

FIGS. 5 and 6 illustrate another embodiment of the fishing accessory that includes a second clasp 40 that can be used to vary the length of the leash between the mesh enclosure 12 and the fishing line 16. In addition to the first clasp 34, which may be used to close the mesh enclosure 12 and secure the payload within, a second clasp 40 may be added to the free end of leash 14 to change the length of leash 14 that runs between the fishing line 16 or swivel 18 and the mesh enclosure 12. As illustrated in FIG. 6, adding a clasp to the free end of the leash 14 prevents the full length of the leash 14 from extending between the fishing line 16 and the mesh enclosure 12.

Each of the mesh enclosure 12, leash 14, and clasp 34 may be made of any suitable material or materials of sufficient rigidity to retain its structural integrity and of sufficient durability to withstand the impact and stress incident to the activity of fishing. In a preferred embodiment, the enclosure is formed of a resilient, elastic material, such as a thermoplastic with elastomeric features manufactured using an injection molding process. In general, the cage may be formed of any suitable material, including extruded, expanded, woven, or tubular plastic such as polypropylene, polyethylene, nylon, polyvinyl chloride (PVC), natural fibers such as cotton or burlap, rubber, metal wire, foam, memory foam, or any other suitable material. In one embodiment, the mesh enclosure is formed of a material that is sufficiently elastic to allow the opening to be cinched closed yet sufficiently resilient such that the enclosure maintains a generally spherical shape when empty. The leash may also be formed of any of the aforementioned materials. In one example, the leash may be formed of fishing line. The clasp may be formed of any material that creates suitable friction to hold the clasp in place when closed around the leash, including plastic, rubber, or metal.

The accessory may be made in a variety of different enclosure 12 sizes and leash 14 lengths to accommodate different fishing environments and/or applications. The mesh enclosure 12 may have an unloaded circumference in the range of two inches to 36 inches, but enclosure sizes outside this range are contemplated. The unloaded circumference is a circumference of the enclosure 12 measured at its widest or largest cross section when it does not contain a payload. In one embodiment, the mesh enclosure may have a circumference between five and six inches.

The length of the leash 14 may be in the range of three or four inches up to dozens of feet, depending on the application, but leash lengths outside this range are contemplated. In one embodiment, the leash may have a length of one to two feet. The leash length is a measure of the entire length of the leash 14. The leash 14 illustrated in FIGS. 1-6 is a continuous leash. In other embodiments, one or more pieces of string or line may be used to cinch the opening of the enclosure closed and tie the enclosure to the swivel 18, fishing line 16, fishing rod, or other tackle or rigging. Larger enclosure sizes and/or leash lengths may be useful for deep sea trolling rigs. Smaller enclosure sizes and/or leash lengths may be useful for shallow-water or ice fishing rigs that use smaller fishing rods/reels. In general, the angler can customize the leash length either by using a second clasping mechanism on the existing leash as described above with respect to FIGS. 5 and 6 or by creating a leash of the desired length by threading a length of fishing line or other suitable material around the opening of the mesh enclosure and tying the free ends of the line to create the leash. A longer leash may also be suitable for an application in which the accessory is loaded with a floating payload, where the mesh enclosure 12 floats on the surface and the length of the leash 14 determines the depth of the hook. It may also be beneficial to adjust the length of the leash depending on the length of the leader in bottom fishing applications.

In general, the fishing accessory may take the form of a mesh enclosure with an opening through which the payload can be loaded or unloaded. The opening may have a leash or piece of string of fishing line threaded around the periphery of the opening that cinches the opening closed when pulled tight. This string may include a clasp or clamp that can anchor the string once it is pulled tight and the opening is cinched shut. The clasp can be released to allow the mesh enclosure to be opened again. The free end of the string may be wrapped around, tied to, or clamped to the fishing line to attach the accessory to the fishing line for use when fishing. Alternatively, the fishing line could be threaded directly through any loop or opening in the mesh enclosure. In yet another embodiment, the mesh enclosure may be loaded or unloaded by pushing the payload through any elastic opening in the mesh.

In one embodiment, the cage enclosure includes a means for varying the shape of the enclosure. For instance, in a relaxed, unloaded state, the enclosure may have a generally prolate spheroidal or cigar-like shape. However, if desired, the angler may adjust the shape of enclosure using any means to pull the bottom of the enclosure towards the opening of the enclosure, which forces the enclosure into the shape of an oblate spheroid. In one embodiment, the mechanism may be a pair of loose lines or strings with one end of each anchored near the opening of the enclosure. The opposite ends of the two lines may then be wrapped around the outside of the enclosure and secured at the bottom of the bottom using a second (or third) clasp or closure mechanism. By pulling these lines tight around the bottom of the enclosure and securing them, the bottom end of the enclosure is pulled or squished upwards towards the opening end of the enclosure, causing the sides of the enclosure to expand outward and forcing the enclosure into a more oblate spheroidal shape. Alternatively, after closing the opening and securing the leash, the free end of the leash may be threaded back through the inside of the enclosure from the opening to the bottom and secured at the bottom (using a second clasp or other means) with the desired length to achieve the desired enclosure shape. Generally, the angler may use any means to couple opposite ends of the enclosure in such a way that they can be pulled together or pushed apart to change the shape of the enclosure. For example, the angler may vary the shape of the enclosure between a prolate spheroid and oblate spheroid, which have different hydrodynamic properties that may be desirable in different fishing applications or environments. The prolate spheroid shape has hydrodynamic properties that may reduce drag and wobbling when moved through the water or submerged in a current of water. The oblate spheroid may increase drag and promote a periodic side-to-side or circular wobble about the direction of movement through the water, which may help attract fish.

The enclosure may be loaded with a variety of payloads to suit different types of fishing or different fishing conditions. By way of example, the enclosure may be loaded with an object denser than to water, e.g., a golf ball or a stone, to provide a sinking function. A golf ball sinker promotes longer casting than prior art fishing weights. The golf ball sinker also promotes a bouncing motion as the sinker is moved along the bottom of the body of water. Finally, the golf ball sinker is less likely to become caught or stuck in small crevices formed of rocks, plant life, or other debris in the body of water. The golf ball may have a dimpled, plastic or rubber cover. The golf ball may be a regulation golf ball and have a mass of no more than 1.620 ounces and a diameter of at least 1.68 inches.

Alternatively, the enclosure may be loaded with a payload that is less dense than water, e.g., a bottle cork or balloon or air bladder, to provide a floating function. In other examples, the enclosure may be loaded with a payload that serves as an enticement to target fish. For instance, the enclosure may be loaded with a balloon or bladder that releases chum oil, blood, or other scented liquids that attract fish. As another example, the enclosure could be loaded with a pellet or any material that dissolves in water and releases a scent that entices or attracts fish. When the enclosure is loaded with a material that dissolves over time, the cage may initially provide a density function (either floating or sinking) that attenuates over time. The enclosure may also be loaded with a combination of elements, such as a sinker and a scented pellet to attract fish.

The accessory provides the benefit of allowing for ad-hoc payloads that suit the angler's needs. For example, a hiker who forgets or does not want to carry fishing weights on her hike can instead find and use a stone or rock as the accessory payload in order to provide a sinking function while fishing. Similarly, a piece or wood, bottle cork, empty bottle, or balloon can be used as a payload to achieve a floating function.

In another embodiment, the payload could also be live bait, such as bait fish, shrimp, crab, sand fleas, etc. Loading the accessory with live bait does not require impaling the bait with a hook, and thus the bait will remain alive longer than when used directly on a hook. The bait may continue to swim or wriggle inside the mesh enclosure and thus attract more fish to the area and improve the angler's chances of hooking the target fish.

In addition to using payloads of different sizes, densities, and scents to achieve different effects, one may also use payloads of different shapes to achieve different behavior in the water. For example, the enclosure may be loaded with an egg-shaped or spoon-shaped object that moves irregularly or wobbles when pulled through the water on a trolling line. The shaking of the enclosure causes similar movement in the lure or bait. This movement may mimic that of a fish in distress and attract predator fish as a result. In general, the size, weight, construction, material, and surface properties of the payload can be varied to enhance the fishing experience.

The enclosure can also accommodate other useful payload such as one or more underwater sensors or test kits. In one embodiment, the enclosure can accommodate an underwater depth sensor that stores real-time depth readings. These readings may be stored in the sensor device and retrieved from the device via Bluetooth, USB cable, or other communication protocol when the user is done fishing. This data may be useful to the user by revealing which depth ranges yield the most successful results for catching specific types of fish, etc. In combination with a sinking device, the depth sensor readings could also allow the user to map and understand the depth and contours of the bottom of the body of water in which they are fishing. Other types of sensors could be used in place of or in combination with the depth sensor. For example, the enclosure could also accommodate a temperature sensor for obtaining temperature readings, or a current measuring device for measure the velocity of underwater currents. The enclosure could also accommodate a motion sensor that allows the user to analyze the motion of the cage (and thus the bait or lure) in a two- or three-dimensional coordinate system. In other embodiments, the enclosure may accommodate other types sensors or test kits. For example, the enclosure could accommodate test strips for testing the chemical properties of the water, or for collecting environmental DNA samples that can be used to reveal the presence of specific species of fish or other living organisms in the water.

While certain exemplary embodiments have been described and shown in the accompanying drawings, it is to be understood that such embodiments are merely illustrative and not restrictive on the broader disclosure, and that this disclosure not be limited to the specific constructions and arrangements shown and described, since various other modifications may occur to those ordinarily skilled in the art.

What is claimed is:

1. An adaptable fishing accessory comprising:
a generally spherical cage enclosure that encloses a payload and is formed of a mesh with an opening located at a first pole of the enclosure;
a leash including a first part that is threaded around the opening of the enclosure and a second part that is coupled to a line that is coupled to a fishing rod; and
a clasp releasably coupled to the leash in a manner that prevents the prevents a length of the first part of the leash from changing.

2. The apparatus of claim 1, wherein the enclosure is flexible.

3. The apparatus of claim 2, wherein the enclosure is composed of a thermoplastic with elastomeric features.

4. The apparatus of claim 2, wherein the enclosure is composed of a plastic.

5. The apparatus of claim 2, wherein the enclosure is composed of a rubber.

6. The apparatus of claim 2, wherein the enclosure is composed of a metal wire.

7. The apparatus of claim 1, wherein the enclosure has an unloaded circumference of less than six inches

8. The apparatus of claim 1, wherein the at least one leash has a length of at least eight inches.

9. The apparatus of claim 1, wherein the at least one leash has a length of less than eight inches.

10. The apparatus of claim 1, wherein pulling on the leash causes the opening to shrink.

11. The apparatus of claim 1, wherein the enclosure has the shape of an oblate spheroid.

12. The apparatus of claim 1, wherein the enclosure has the shape of a prolate spheroid.

13. The apparatus of claim 1, wherein the enclosure includes a line that couples the first pole of the enclosure to an opposite pole of the enclosure such that shortening the line changes the shape of the enclosure.

14. The apparatus of claim 1, wherein the at least one leash is wrapped around a ring of a swivel coupled to the fishing line.

15. The apparatus of claim 1, wherein the leash is wrapped around the fishing line.

16. The apparatus of claim 1, wherein the payload has a density greater than the density of water.

17. The apparatus of claim 1, wherein the payload has a density less than the density of water.

18. The apparatus of claim 1, wherein the payload includes chum or smelt oil.

19. The apparatus of claim 1, wherein the payload has a mass of at most 1.7 ounces.

20. The apparatus of claim 1, where the payload has a diameter of at least 1.6 inches.
